(19) United States
(12) Patent Application Publication
(10) Pub. No.: US 2007/0183822 A1
(43) Pub. Date: Aug. 9, 2007

(54) Fixing device and image forming apparatus

(75) Inventors: Atsunori Kitazawa, Nagano-ken (JP); Yoshiro Koga, Nagano-ken (JP); Toru Fujita, Nagano-ken (JP); Masahide Nakamura, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION, Tokyo (JP)

(21) Appl. No.: 11/730,419

(22) Filed: Apr. 2, 2007

Related U.S. Application Data
(62) Division of application No. 10/705,261, filed on Nov. 12, 2003.

(30) Foreign Application Priority Data
Nov. 20, 2002 (JP) 2002-336638
Nov. 20, 2002 (JP) 2002-336639

(51) Int. Cl. G03G 15/20

(52) U.S. Cl. 399/329

(57) ABSTRACT

A nip pressure at an inlet site of a nip portion 69 is higher than a nip pressure at an exit site of the nip portion 69. Thus, the relatively higher nip pressure is applied to a recording medium 4 at the inlet site of the nip portion 69 thereby squeezing out a carrier liquid L from space between toner particles T and between the recording medium 4 and the toner T. Hence, the amount of carrier liquid L remaining in the spaces is notably decreased. The recording medium 4 with a decreased amount of carrier liquid L carried thereon is moved to the exit site of the nip portion 69, where the toner T is brought into pressure contact with one side S1 of the recording medium 4 thereby to be fixed to the recording medium 4.

### BACKGROUND OF THE INVENTION

1. Field of the Invention

The present invention relates to a technique for fixing an unfixed toner image to a recording medium, the toner image formed with a liquid developer wherein a toner is dispersed in a carrier liquid.

2. Description of the Related Art

Conventionally, there has been known an image forming apparatus wherein an image forming process is performed using a liquid developer including a toner dispersed in a carrier liquid thereby forming a toner image on a recording medium such as copy paper, transfer paper and other general paper, and then the resultant toner image, which is unfixed, is fixed to the recording medium by means of a fixing device. The fixing device for use in such an image forming apparatus of a liquid development system includes one disclosed in Japanese Unexamined Patent Publication No. 2000-112269, for example. The fixing device includes a heat roller and a plurality of support rollers arranged circumferentially of the heat roller in opposing relation therewith. The device fixes to the recording medium the toner image unfixedly carried thereon by passing the recording medium through a nip portion defined between the heat roller and the support rollers.

In the fixing device, the heat roller contacts a front side of the recording medium carrying thereon the unfixed toner image, while on the other hand, the individual support rollers press on a back side of the recording medium for pressing the recording medium against the heat roller. The support roller is set for a pressing force of not more than 50 g/cm per unit length with respect to an axial direction thereof. This results in a sufficient reduction of contact pressure at which the recording medium is pressed against the heat roller and hence, the amount of toner offset to the heat roller after image fixiation is decreased.

By the way, the image forming apparatus of the liquid development system uses, as a developing agent, the liquid developer including the toner dispersed in the carrier liquid. Accordingly, at the point of time that a toner image formed by a developing process is transferred onto a recording medium, the recording medium carries thereon not only the solid toner but also the carrier liquid in a mixed state and in this state, a fixing process is carried out. While the recording medium is passed through the nip portion or moved across a nip width, a surface of the recording medium is brought into pressure contact with the heat roller whereby the toner is fixed to the recording medium. It is therefore easy to suppose that a pressure distribution at the nip portion has a significant influence on the fixing characteristics of the developer. In a case where a volatile carrier is used as the carrier liquid, a relatively small amount of carrier liquid remains on the recording medium because a part of the carrier liquid is evaporated due to heat applied during the fixing process. In a case where a non-volatile carrier is used as the carrier liquid, in particular, there occurs little evaporation of the carrier liquid. Hence, the liquid developer including the non-volatile carrier is more susceptible to the pressure distribution than the liquid developer including the volatile carrier.

Unfortunately, the conventional image forming apparatuses of the liquid development system give no consideration to the pressure distribution at the nip portion, although the value of the pressure applied at the nip portion is sufficiently considered, as described above. Thus, there is still much to be improved with respect to the fixing performance.

### SUMMARY OF THE INVENTION

A primary object of the invention is to provide a fixing device and an image forming apparatus capable of fixing a toner image onto a recording medium with high fixing performance, the toner image formed with a liquid developer including a toner dispersed in a carrier liquid.

According a first aspect of the present invention, a fixing device comprises: a contact member arranged to be able to contact one side of a recording medium on which side an unfixed toner image is carried, the toner image formed with a liquid developer including a toner dispersed in a carrier liquid; and a pressing member pressing on the other side of the recording medium for pressing the recording medium against the contact member, wherein the unfixed toner image is fixed to the one side of the recording medium by passing the recording medium through a nip portion defined between the contact member and the pressing member; and wherein a nip pressure at an inlet site of the nip portion is set higher than a nip pressure at an exit site of the nip portion.

According a second aspect of the present invention, an image forming apparatus comprises: image forming means for forming a toner image on a surface of an image carrier by using a liquid developer in which a toner is dispersed in a carrier liquid; and transferring/fixing means for concurrently transferring and fixing the toner image to one side of a recording medium, wherein the transferring/fixing means includes a contact member arranged to be able to contact a back side of the image carrier and a pressing member pressing on the other side of the recording medium for pressing the recording medium against the surface of the image carrier, and performs the transferring/fixing process by passing the recording medium and the image carrier through a nip portion defined between the contact member and the pressing member; and wherein a nip pressure at an inlet site of the nip portion is set higher than a nip pressure at an exit site of the nip portion.

According a third aspect of the present invention, a fixing device comprises: a heat contact member arranged to be able to contact one side of a recording medium while heating the one side of the recording medium on which side an unfixed toner image is carried, the toner image formed with a liquid developer including a toner dispersed in a carrier liquid; and a pressing member pressing on the other side of the recording medium for pressing the recording medium against the heat contact member, the fixing device operating to fix the unfixed toner image to the one side of the recording medium by passing the recording medium through a nip portion defined between the heat contact member and the pressing member, wherein a nip pressure at an inlet site of the nip portion is set lower than a nip pressure at an exit site of the nip portion.

According a fourth aspect of the present invention, an image forming apparatus comprises: image forming means for forming a toner image on a surface of an image carrier by using a liquid developer including a toner dispersed in a carrier liquid; and transferring/fixing means for concurrently transferring and fixing the toner image to one side of the recording medium, wherein the transferring/fixing means includes a heat contact member arranged to be able to contact a back side of the image carrier while heating the back side thereof and a pressing member pressing on the other side of the recording medium for pressing the recording medium against the surface of the image carrier, and performs the transferring/fixing process by passing the recording medium and the image carrier through a nip portion defined between the heat contact member and the pressing member; and wherein a nip pressure at an inlet site of the nip portion is set lower than a nip pressure at an exit site of the nip portion.

According a fourth aspect of the present invention, an image forming apparatus comprises: image forming means for forming a toner image on an image carrier by using a liquid developer including a toner dispersed in a carrier liquid; transfer means for transferring the toner image, formed by the image forming means, to one side of a recording medium; and fixing means having the same arrangement as the fixing device and operating to fix the unfixed toner image to the recording medium, the unfixed toner image transferred to the one side of the recording medium by the transfer means.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a diagram showing an internal arrangement of a printer as an image forming apparatus according to a first embodiment of the invention;

FIG. 2 is a block diagram showing an electrical arrangement of the printer of FIG. 1;

FIG. 3 is a diagram showing a fixing unit as a fixing device according to the first embodiment of the invention;

FIG. 4 is a graph representing a nip pressure distribution at a nip portion of the fixing unit of FIG. 3;

FIG. 5 is a diagram showing a fixing unit as a fixing device according to a second embodiment of the invention;

FIG. 6 is a graph representing a nip pressure distribution at a nip portion of the fixing unit of FIG. 5;

FIG. 7 is a diagram showing a fixing unit as a fixing device according to a third embodiment of the invention;

FIG. 8 is a diagram showing a transferring/fixing unit as a fixing device according to a fourth embodiment of the invention;

FIG. 9 is a diagram showing a fixing unit as a fixing device according to a sixth embodiment of the invention;

FIG. 10 is a graph representing a nip pressure distribution at a nip portion of the fixing unit of FIG. 9;

FIG. 11 is a diagram showing a fixing unit as a fixing device according to a seventh embodiment of the invention;

FIG. 12 is a graph representing a nip pressure distribution at a nip portion of the fixing unit of FIG. 11;

FIG. 13 is a diagram showing a transferring/fixing unit as a fixing device according to a ninth embodiment of the invention; and

FIG. 14 is a block diagram showing an electrical arrangement according to another embodiment of the invention.

### DETAILED DESCRIPTION OF THE PREFERRED EMBODIMENTS

### First Embodiment

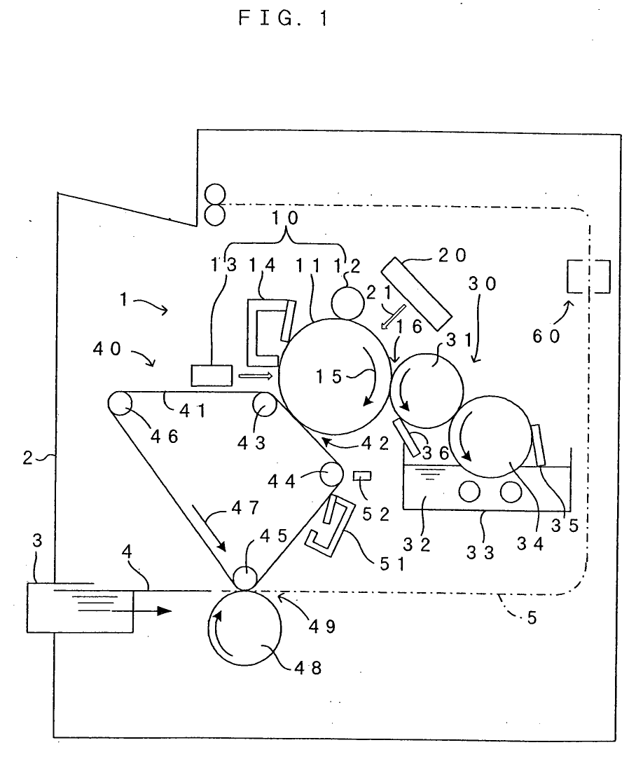

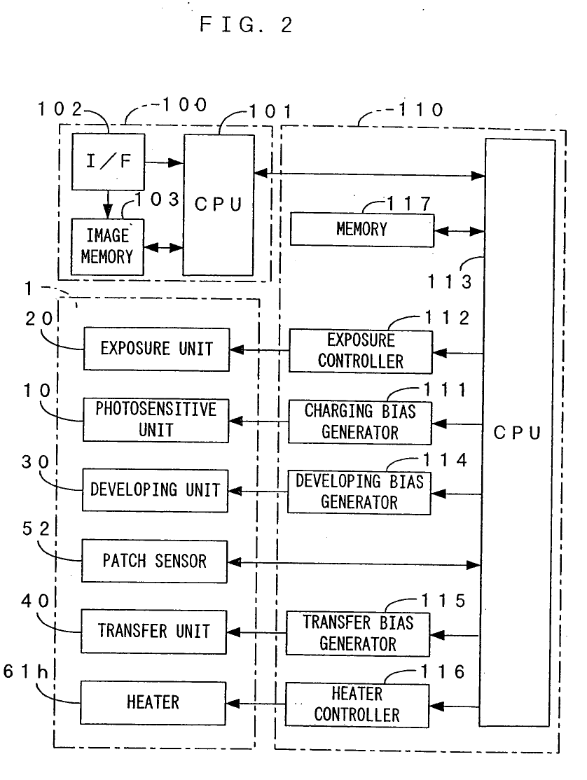

FIG. 1 is a diagram showing an internal arrangement of a printer as an image forming apparatus according to a first embodiment of the invention. FIG. 2 is a block diagram showing an electrical arrangement of the printer. The printer is an image forming apparatus of the liquid development system, which forms a monochromatic image using a liquid developer of black (K). The printer operates as follows. When a print command signal including an image signal is applied to a main controller 100 from an external apparatus such as a host computer, an engine controller 110 controls individual parts of an engine 1 according to a control signal from the main controller 100. Thus, an image corresponding to the above image signal is outputted as printed on a transfer paper, a copy paper or other general paper (hereinafter, referred to as “recording medium”) 4 delivered from a sheet feeder cassette 3 disposed at a lower part of an apparatus body 2.

The engine 1 includes a photosensitive unit 10, an exposure unit 20, a developing unit 30, a transfer unit 40, a fixing unit 60 and the like. Of these units, the photosensitive unit 10 is provided with a photosensitive member 11 free to rotate in a direction of an arrow 15 shown in FIG. 1 (clockwise direction as seen in the figure). A charger 12, a developing roller 31, the transfer unit 40, a discharger 13 and a cleaner 14 are arranged around the photosensitive member 11 along the rotational direction 15. According to the embodiment, the charger 12 comprises a charging roller which is applied with a charging bias from a charging bias generator 111 such as to uniformly charge an outer periphery of the photosensitive member 11 to a predetermined surface potential Vd (e.g., Vd=DC+600V). The charger functions as charging means.

A surface region of the photosensitive member 11 between the charger 12 and the developing roller 31 is defined as a light irradiation region which is exposed to light beams 21 from the exposure unit 20. An electrostatic latent image is formed on the light irradiation region. Specifically, the exposure unit 20 irradiates the photosensitive member 11 with the light beams 21 according to a control command from an exposure controller 112 thereby forming thereon the electrostatic latent image corresponding to the image signal. When, for instance, the external apparatus such as a host computer applies the print command signal including the image signal to a CPU 101 of the main controller 100 via an interface 102, a command from the CPU 101 of the main controller 100 is received by a CPU 113 which, in turn, outputs a control signal, corresponding to the image signal, to the exposure controller 112 in a predetermined timing. In response to the control command from the exposure controller 112, the exposure unit 20 irradiates the light beams 21 upon the photosensitive member 11 so as to form the electrostatic latent image on the photosensitive member 11 in correspondence to the image signal. In a case where a patch image, as required, is formed, a control signal corresponding to a patch image signal representative of a previously defined pattern (such as a solid image, fine line image or hollow fine-line image) is applied from the CPU 113 to the exposure controller 112 such that an electrostatic latent image corresponding to the pattern is formed on the photosensitive member 11.

The resultant electrostatic latent image is developed into a visible image by way of a toner supplied from the developing roller 31 of the developing unit 30. The developing unit 30 includes, in addition to the developing roller 31, a reservoir 33 storing a liquid developer 32 therein; an application roller 34 for applying the liquid developer 32 to the developing roller 31 as lifting up the liquid developer 32 stored in the reservoir 33; a regulating blade 35 for limiting a liquid developer layer over the application roller 34 to a constant thickness; and a cleaning blade 36 for removing the liquid developer remaining on the developing roller 31 after toner supply to the photosensitive member 11. The developing roller 31 is rotated in the opposite direction to the rotation of the photosensitive member 11 (counter-clockwise direction as seen in the figure) at the same circumferential speed as the photosensitive member 11. On the other hand, the application roller 34 is rotated in the same direction as the developing roller 31 (counter-clockwise direction as seen in the figure) at about twice the circumferential speed of the developing roller 31.

According to the embodiment, the liquid developer 32 comprises a toner and a carrier liquid, the toner including a color pigment, a resin for binding the color pigment, an electric charge control agent for electrifying the toner to a predetermined electric charge, a dispersing agent for homogeneously dispersing the color pigment and the like. The toner is dispersed in the carrier liquid. The embodiment employs a non-volatile carrier as the carrier liquid. The non-volatile carrier includes, for example, a silicone oil such as polydimethylsiloxane oil and the like. The toner is adjusted to a density of 5 to 40 wt %, which is higher than that of a low-density developer (toner density of 1 to 2 wt %) widely used in the liquid development system. The type of the carrier liquid is not limited to the silicone oil. While the viscosity of the liquid developer 32 may be decided according to the type of a used carrier liquid, the components of the toner, the toner density and the like, the liquid developer of the embodiment has a viscosity of 50 to 6000 mPa(s, which is higher than that of the low-density developer.

The developing unit 30 of this arrangement operates as follows. The liquid developer 32 stored in the reservoir 33 is lifted up by the application roller 34, while the liquid developer layer over the application roller 34 is limited to a constant thickness by means of the regulating blade 35. The liquid developer 32 in such a consistent layer is allowed to adhere to a surface of the developing roller 31 so as to be delivered to a development position 16 opposite the photosensitive member 11 in conjunction with the rotation of the developing roller 31. The toner is, for example, positively charged by the effect of the electric charge control agent and the like. At the development position 16, the toner is transferred from the developing roller 31 to the photosensitive member 11 by way of a developing bias Vb applied to the developing roller 31 from a developing bias generator 114. Thus, the electrostatic latent image is developed into a visible image. The developing bias Vb is determined by an optimization process using the patch image and is on the order of Vb=DC+400V, for example.

The toner image thus formed on the photosensitive member 11 is transported by the rotating photosensitive member 11 to a primary transfer position 42 opposite an intermediate transfer belt 41. The intermediate transfer belt 41 is run about a plurality of rollers 43-46 and is driven by an unillustrated motor into a cycling motion in the opposite direction 47 (counter-clockwise direction as seen in FIG. 1) to the rotation of the photosensitive member 11 at the same circumferential speed as that of the photosensitive member 11. The toner image on the photosensitive member 11 is transferred to the intermediate transfer belt 41 when a primary transfer bias (e.g., DC−400V) is applied to the intermediate transfer belt 41 from a transfer bias generator 115. Thus, the toner image is formed on the intermediate transfer belt 41 equivalent to an “image carrier” of the invention, whereas the photosensitive unit 10, the exposure unit 20 and the developing unit 30 function as “image forming means” of the invention. Residual potential on the photosensitive member 11 after the primary image transfer is eliminated by the discharger 13 such as comprised of an LED or the like, whereas the remaining liquid developer is removed by the cleaner 14.

Of the rollers 43-46 with the intermediate transfer belt 41 run thereabout, the roller 45 at the lowermost position is opposed by a roller 48. A primary transfer toner image primarily transferred to the intermediate transfer belt 41 is delivered to a secondary transfer position 49 between the rollers 45, 48 in conjunction with the rotation of the intermediate transfer belt 41. On the other hand, a recording medium 4 accommodated in the sheet feeder cassette 3 is delivered to the secondary transfer position 49 by means of a transport driver (not shown) operative in synchronism with the transportation of the primary transfer toner image. The roller 48 is rotated in the opposite direction to the movement of the intermediate transfer belt 41 (clockwise direction as seen in FIG. 1) at the same circumferential speed as the intermediate transfer belt 41. The primary transfer toner image on the intermediate transfer belt 41 is secondarily transferred to the recording medium 4 when a secondary transfer bias (e.g., −100 (A under constant current control) is applied to the intermediate transfer belt 41 from the transfer bias generator 115. According to the embodiment, the transfer unit 40 functions as “transfer means” of the invention, whereas the intermediate transfer belt 41 equivalent to the “image carrier” of the invention temporarily carries thereon the toner image before the toner image is transferred to the recording medium 4. As a matter of course, however, the toner image formed on the photosensitive member 11 may also be directly transferred to the recording medium 4. In this case, the photosensitive member 11 is equivalent to the “image carrier” of the invention.

The recording medium 4 with the toner image secondarily transferred thereto is transported along a predetermined transport path 5 (indicated by dashed line in FIG. 1) so as to be subjected to the fixing unit 60 equivalent to “fixing means” or a “fixing device” of the invention for fixing the toner image to the recording medium 4. Then, the resultant recording medium 4 is discharged to a discharge tray disposed at an upper part of the apparatus body 2. The arrangement and operations of the fixing unit 60 will be described in details hereinlater.

In FIG. 1, a reference numeral 51 represents a cleaner for removing the liquid developer remaining on the intermediate transfer belt 41 after the secondary image transfer. A reference numeral 52 represents a patch sensor which is a reflection-type optical sensor and operative to sense a density of a patch image formed on the photosensitive member 11. Referring to FIG. 2, the main controller 100 includes an image memory 103 for storing an image signal supplied from the external apparatus via the interface 102. Receiving a print command signal including the image signal from the external apparatus via the interface 102, the CPU 101 converts the received signal into job data of a format suited for directing the operations of the engine 1 and outputs the resultant data to the engine controller 110. A memory 117 of the engine controller 110 includes a ROM for storing a control program for the CPU 113 which includes previously defined fixed data; a RAM for temporarily storing control data for the engine 1 or operation results given by the CPU 113; and the like.

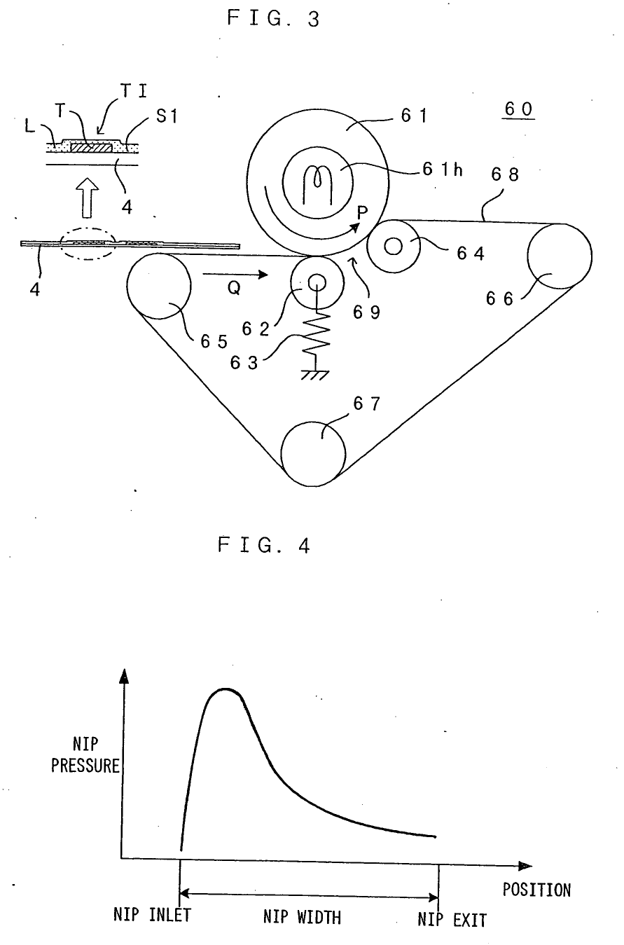

FIG. 3 is a diagram showing a fixing unit as a fixing device according to the first embodiment of the invention. FIG. 4 is a graph representing a nip pressure distribution at a nip portion of the fixing unit of FIG. 3. Referring to these figures, the arrangement and operations of the fixing unit 60 will be described in details as below. The fixing unit 60 includes a heat roller (contact member) 61 arranged to be able to contact one side S1 of the recording medium 4 (FIG. 3). An unillustrated motor applies a rotational drive force to the heat roller 61 for driving the heat roller into rotation in a direction of an arrow P shown in the figure. The heat roller 61 incorporates therein a heater 61h such that a fixing temperature in the fixing unit 60 may be adjusted to an arbitrary level by controlling the operation of the heater 61h based on a control signal from a heater controller 116.

The fixing unit 60 is arranged as follows. A nip roller 62 is pressed against the heat roller 61 by means of a helical compression spring 63. In addition, a nip roller 64 is abutted against the heat roller 61. Rollers 65-67 are arranged around the nip rollers 62, 64, and an endless belt 68 is run about these rollers 62, 64-67. A motor is operated to apply a rotational drive force thereof to one of these rollers thereby driving the endless belt 68 into a cycling motion in a direction of an arrow Q shown in the figure. Thus, an outside surface of the endless belt 68 contacts the heat roller 61 at its portion stretched between the nip rollers 62, 64, thereby defining a nip portion 69. The fixing process is carried out by passing the recording medium 4, delivered from the transfer unit 40, through the nip portion 69. According to the embodiment, the plural rollers 62, 64-67 and the endless belt 68 run about the rollers 62, 64-67 constitute a “pressing member” of the invention. The nip portion 69 is defined by partially bringing the outside surface of the endless belt 68 into pressure contact with the heat roller 61 by means of the two nip rollers 62, 64.

According to the embodiment, the nip roller 64 equivalent to an exit side of the nip portion 69 is simply abutted against the heat roller 61, whereas the nip roller 62 equivalent to an inlet side of the nip portion 69 is strongly pressed against the heat roller 61 by the helical compression spring 63. Hence, nip pressure presents a pressure distribution as shown in FIG. 4, as distributed along a length of the nip portion 69 in the direction P, Q of transport of the recording medium 4 or along a nip width. That is, a nip pressure at an inlet site of the nip portion 69 is higher than that at an exit site of the nip portion 69. Accordingly, when the recording medium 4 is delivered to the fixing unit 60 from the transfer unit 40, the fixing process takes place in association with the following phenomena.

Firstly, the recording medium 4 delivered to the fixing unit 60 carries an unfixed toner image TI on one side S1 thereof (the front side in this embodiment, see FIG. 3), the toner image formed with the liquid developer. Prior to the fixing process, a solid toner T and a carrier liquid L are present on the one side of the recording medium 4 in a mixed state. When the recording medium 4 enters the inlet site of the nip portion 69 as carrying thereon the mixture of the solid toner T and the carrier liquid L, the recording medium 4 receives the relatively higher nip pressure. It is noted here that the “relatively higher nip pressure” means a nip pressure suited for fixing the toner T in the liquid developer to the recording medium 4 or the pressure higher than the nip pressure at the exit site. The relatively higher nip pressure may be decided according to the components of the liquid developer, the arrangement of the apparatus or the material of the recording medium 4.

If such a relatively higher nip pressure is applied to the recording medium 4 at the inlet site of the nip portion 69, the carrier liquid L is squeezed out from space between the toner particles T so that the amount of carrier liquid L remaining in the space between the toner particles T is notably decreased. This is because the carrier liquid L has a higher fluidity than the solid toner T so that the application of the nip pressure causes the carrier liquid to move in preference to the toner T. Because of the same reason, the amount of carrier liquid L remaining in space between the recording medium 4 and the toner T is also decreased significantly just as in the space between the toner particles T.

The recording medium 4 with the decreased amount of carrier liquid remaining thereon is moved to the exit site of the nip portion 69 where the toner T is brought into pressure contact with the one side S1 of the recording medium 4 so as to be fixed to the recording medium 4. The nip pressure at the exit site is set to a level suited for toner fixing so that the fixing process may be carried out in a favorable manner. Furthermore, since the fixing process is performed with the carrier liquid L positively removed from the spaces between the toner particles T and between the recording medium 4 and the toner T, the fixing strength of the toner can be increased and an excellent fixing performance is achieved.

As described above, the first embodiment is arranged such that the nip pressure at the inlet site of the nip portion 69 is higher than that at the exit site of the nip portion 69 and hence, the toner image TI formed with the liquid developer including the toner T dispersed in the carrier liquid L can be fixed to the recording medium 4 with high fixing performance.

### Second Embodiment

According to the first embodiment, the outside surface of the endless belt 68 is partially brought into pressure contact with the heat roller 61 thereby to define the nip portion 69. However, as suggested by another embodiment shown in FIG. 5, an alternative arrangement may be made such that a pressure pad is used in place of the two nip rollers 62, 64 for holding a part of the outside surface of the endless belt 68 in pressure contact with the heat roller 61.

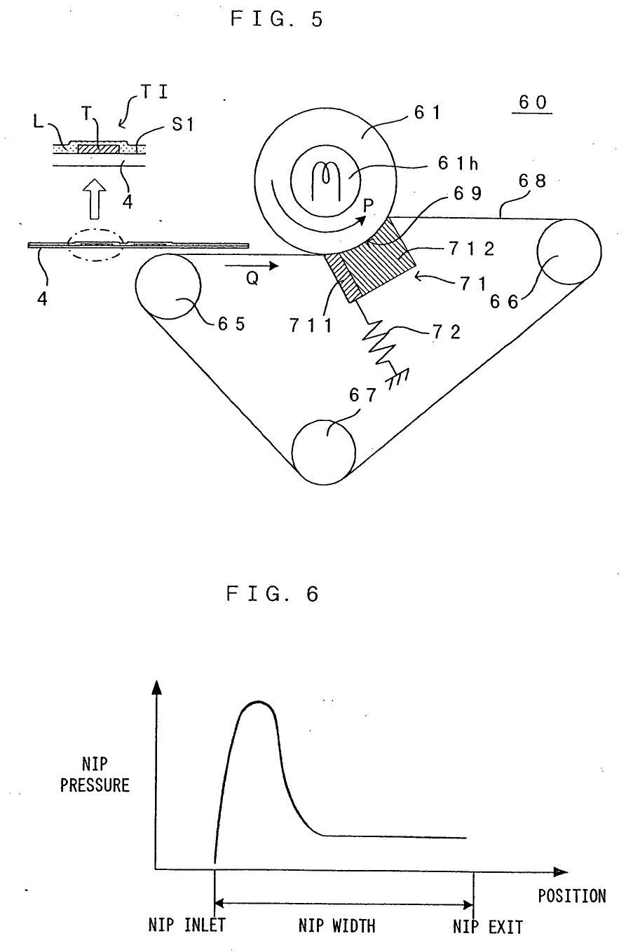

FIG. 5 is a diagram showing a fixing unit as a fixing device according to a second embodiment of the invention, whereas FIG. 6 is a graph representing a nip pressure distribution at a nip portion of the fixing unit of FIG. 5. Referring to these figures, the arrangement and operations of the fixing unit 60 according to the embodiment will hereinbelow be described in details. The following description will focus on difference from the first embodiment. The fixing unit 60 is provided with a pressure pad 71 in stead of the nip rollers. Specifically, the fixing unit includes the three rollers 65-67, about which the endless belt 68 is run. A motor is operated to apply a rotational drive force thereof to one of these rollers thereby driving the endless belt 68 into a cycling motion in a direction of an arrow Q shown in the figure. Disposed inside of the endless belt 68 is the pressure pad 71 in a non-rotatable state, the pressure pad holding the endless belt 68 in pressure contact with the heat roller 61 for the overall length of the nip portion thereby establishing the nip portion 69. Thus, the outside surface of the endless belt 68 contacts the heat roller 61 at place where the pressure pad 71 is located, thereby defining the nip portion 69. The fixing process is carried out by passing the recording medium 4, delivered from the transfer unit 40, through the nip portion 69. According to the embodiment, the plural rollers 65-67, the endless belt 68 run about the rollers 65-67 and the pressure pad 71 constitute the “pressing member” of the invention.

As shown in FIG. 5, the pressure pad 71 includes two pad portions 711, 712. The pad portion 711 is disposed at the inlet site of the nip portion 69 and is pressed against the heat roller 61 by means of a helical compression spring 72. The other pad portion 712, on the other hand, is disposed at the exit site of the nip portion 69 and is simply abutted against the heat roller 61. Hence, the nip pressure presents a pressure distribution as shown in FIG. 6, as distributed along the length of the nip portion 69 in the direction P, Q of transport of the recording medium 4 or along the nip width. That is, the nip pressure at the inlet site of the nip portion 69 is higher than that at the exit site thereof.

When the recording medium 4 is delivered from the transfer unit 40 to the fixing unit 60 thus arranged, the fixing process is carried out in a similar manner to the first embodiment. When the recording medium 4 delivered to the fixing unit 60 enters the inlet site of the nip portion 69, the recording medium 4 is subjected to the relatively higher nip pressure such that the carrier liquid L remaining in space between the toner particles T is significantly reduced as squeezed out therefrom and that the carrier liquid L remaining in space between the recording medium 4 and the toner T is also significantly decreased just as in the space between the toner particles T. Then, the recording medium 4 with the decreased amount of carrier liquid remaining thereon is moved to the exit site of the nip portion 69, where the toner T is brought into pressure contact with the one side S1 of the recording medium 4 so as to be fixed to the recording medium 4. Thus, the fixing process may be performed under the nip pressure suitably conditioned for the toner fixing and in the state where the carrier liquid L is positively removed from the spaces between the toner particles T and between the recording medium 4 and the toner T. As a consequence, the fixing strength can be increased and the excellent fixing performance is achieved.

According to the embodiment, the pressure pad 71 is used to define the nip portion 69 and hence, the following working effect can be obtained. Specifically, the embodiment is adapted to provide a constant nip pressure at the exit site of the nip portion 69, as shown in FIG. 6. This ensures that the moving speed of the recording medium 4 is assuredly prevented from fluctuating during the passage of the recording medium 4 through the nip portion 69. As a result, the slippage of the recording medium is obviated so that a favorably fixed toner image may be obtained.

### Third Embodiment

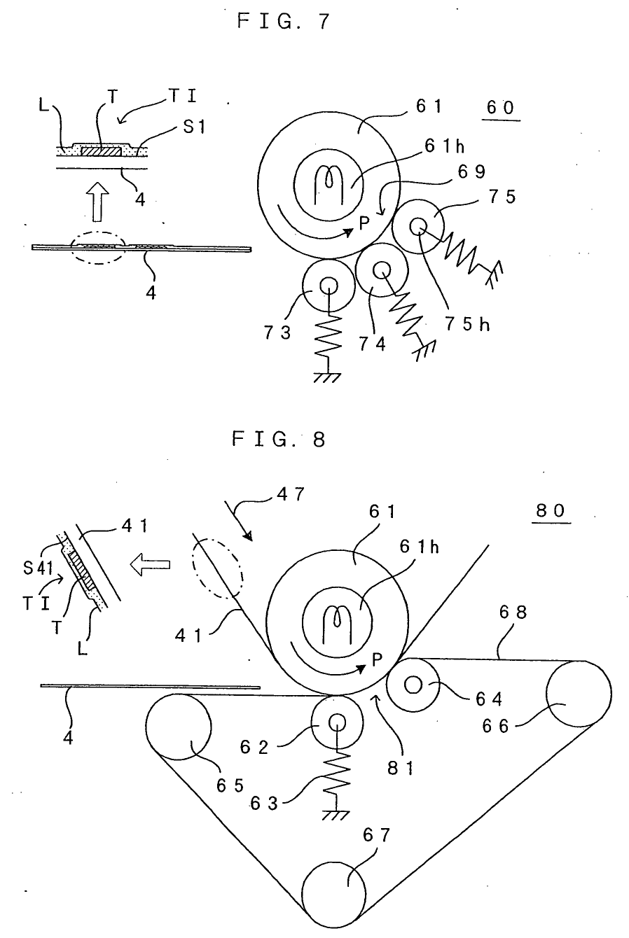

While both the first and second embodiments adopt a so-called belt nip system, the nip system is not limited to this. A roller nip system, as shown in FIG. 7 for example, may be used.

FIG. 7 is a diagram showing a fixing unit as a fixing device according to a third embodiment of the invention. The fixing unit 60 includes the heat roller 61 equivalent to the “contact member” of the invention, and a plurality of pressure rollers 73-75 equivalent to the “pressing member” of the invention. Similarly to the first and second embodiments, the heat roller 61 is applied with the rotational drive force from the unillustrated motor so as to be driven into rotation in the direction of the arrow P as seen in the figure. The rollers 73-75 adjoin each other as arranged along the rotation direction P of the heat roller 61 and are also pressed against the heat roller 61 thereby defining the nip portion 69.

Of these rollers 73-75, the roller 73 on the inlet side of the nip portion 69 is designed to have a higher pressing force than the roller 75 on the exit side of the nip portion 69. Thus, the nip pressure presents the same pressure distribution as that shown in FIG. 4, as distributed along the length of the nip portion 69 in the direction P of transport of the recording medium 4 or along the nip width. Accordingly, when the recording medium 4 is delivered from the transfer unit 40 to the fixing unit 60 thus arranged, the same phenomena as in the foregoing embodiments occur at the inlet site of the nip portion 69. That is, the carrier liquid L is squeezed out from the spaces between the toner particles T and between the recording medium 4 and the toner T. Then, the recording medium 4 with the decreased amount of carrier liquid remaining thereon is moved to the exit of the nip portion 69 so as to allow the toner T to be fixed to the recording medium 4. Therefore, the fixing process may be performed under the nip pressure adapted for the toner fixing and in the state where the carrier liquid L is positively removed from the spaces between the toner particles T and between the recording medium 4 and the toner T. As a consequence, the fixing strength can be increased and the excellent fixing performance is achieved.

It is noted here that at least the roller 75 on the exit side may be further provided with heating means such as a heater 75h. The device can increase the fixing strength of the toner T to the recording medium 4 by heating the roller 75, thus achieving an even higher fixing performance.

### Fourth Embodiment

According to the first to the third embodiments, the toner image is transferred to the recording medium 4 and thereafter, the fixing process is performed by the fixing unit 60. However, the invention is also applicable to an image forming apparatus adapted to perform the transfer process and the fixing process at a time. Such an apparatus will hereinbelow be described with reference to FIG. 8.

FIG. 8 is a diagram showing a transferring/fixing unit as a fixing device according to a fourth embodiment of the invention. A transferring/fixing unit 80 concurrently performs both the transfer process and the fixing process at the secondary transfer position. The unit principally differs from the foregoing embodiments in that the transfer roller 45 of the transfer unit 40 is replaced by the heat roller 61 as the “contact member” of the invention and that the roller 48 is replaced by the rollers 62, 64-67, helical compression spring 63 and endless belt 68 which serve as the “pressing member” of the invention. That is, the transferring/fixing unit 80 has an arrangement wherein the heat roller 61 is arranged to be able to contact a back side of the intermediate transfer belt 41 serving as the “image carrier” of the invention. The heat roller 61 incorporates therein the heater 61h such that a fixing temperature in the transferring/fixing unit 80 may be adjusted to an arbitrary level by controlling the operation of the heater 61h based on a control signal from the heater controller 116. Otherwise, the embodiment is arranged the same way as the image forming apparatus of FIG. 1. Therefore, the principal part of the transferring/fixing unit 80 is described but the other parts are not described here.

Likewise to the embodiment shown in FIG. 3, the outside surface of the endless belt 68 is pressed against a front side S41 of the intermediate transfer belt 41, run about the heat roller 61, at its portion stretched between the nip rollers 62, 64, thereby defining a nip portion 81. Therefore, when the recording medium 4 is delivered to the transferring/fixing unit 80, both the transfer process and the fixing process can be accomplished at a time by passing the recording medium 4 through the nip portion 81.

In this embodiment, as well, the nip roller 64 equivalent to the exit side of the nip portion 81 is simply abutted against the heat roller 61, whereas the nip roller 62 equivalent to the inlet side of the nip portion 81 is strongly pressed against the heat roller 61 by means of the helical compression spring 63. Hence, the nip pressure presents the pressure distribution as shown in FIG. 4, as distributed along the length of the nip portion 81 in the direction P of transport of the recording medium 4 or along the nip width. Therefore, the embodiment has not only an advantage of concurrently performing the transfer process and the fixing process but also an advantage that the transferring and fixing processes are performed under the nip pressure adapted for the transfer and fixing of the toner and in the state where the carrier liquid L is positively removed from the spaces between the toner particles T and between the recording medium 4 and the toner T. Consequently, the fixing strength can be increased and the excellent fixing performance is achieved.

Although the embodiment adopts the same belt nip system as that of FIG. 3, the nip system is not limited to this. A similar belt nip system to that of FIG. 5 and the roller nip system of FIG. 7 are also usable.

### Fifth Embodiment

According to the first to the fourth embodiments, the fixing process is performed simply by passing the recording medium 4 through the nip portion 69 or the transferring/fixing process is performed simply by passing the intermediate transfer belt 41 and the recording medium 4 through the nip portion 81. Alternatively, there may be further provided electric-field generating means for generating, in the nip portion 69 or 81, an electric field so directed as to move the toner T in the liquid developer 32 toward the recording medium 4. In this case, the toner T is concentrated on the recording medium 4 side so that the carrier liquid L is efficiently removed from the spaces between the toner particles T and between the recording medium 4 and the toner T. Thus, the fixing performance is even further improved.

### Sixth Embodiment

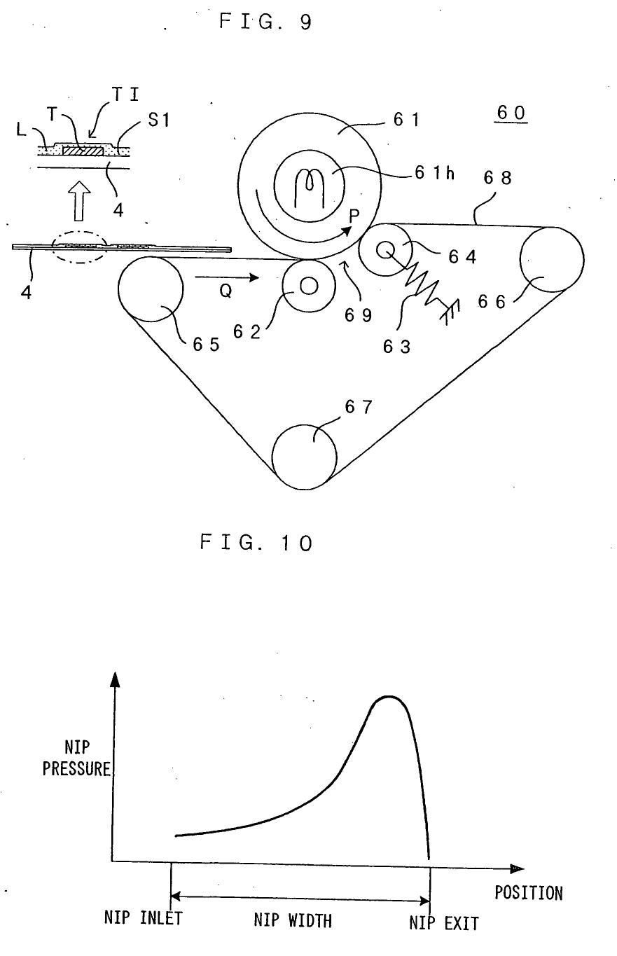

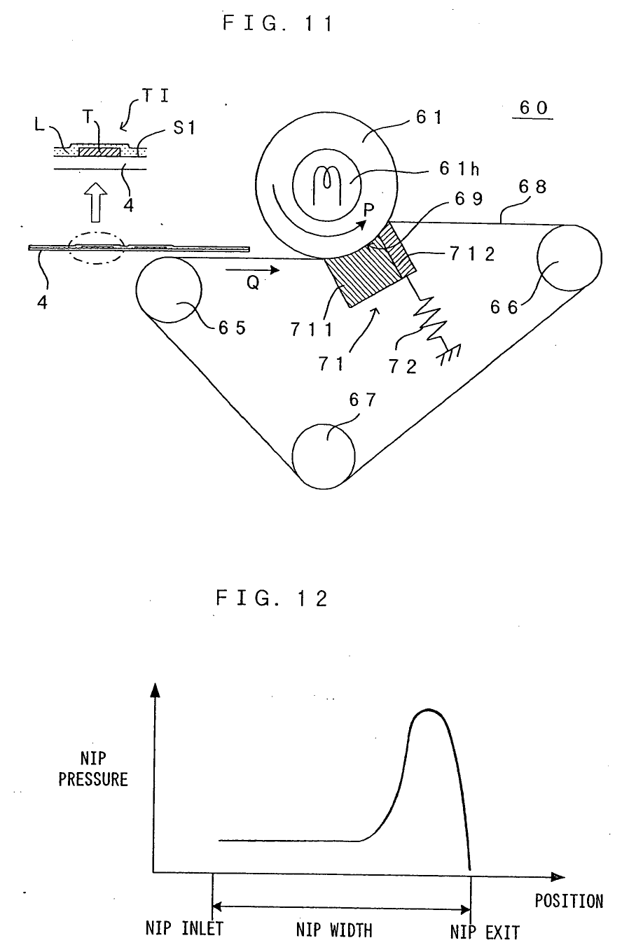

FIG. 9 is a diagram showing a fixing unit as a fixing device according to a sixth embodiment of the invention. FIG. 10 is a graph representing a nip pressure distribution at a nip portion of the fixing unit of FIG. 9. A major difference of the sixth embodiment from the first embodiment consists in the pattern of the pressure distribution. In the fixing unit 60 according to the sixth embodiment, the nip roller 62 is abutted against the heat roller 61, whereas the nip roller 64 is pressed against the heat roller 61 by the helical compression spring 63. The rollers 65-67 are arranged around the nip rollers 62, 64 while the endless belt 68 is run about these rollers 62, 64-67. The motor is operated to apply the rotational drive force thereof to one of these rollers thereby driving the endless belt 68 into a cycling motion in the direction of the arrow Q as shown in the figure. Thus, the outside surface of the endless belt 68 contacts the heat roller 61 at its portion stretched between the nip rollers 62, 64, thereby defining the nip portion 69. The fixing process is accomplished by passing the recording medium 4, delivered from the transfer unit 40, through the nip portion 69. According to the embodiment, the plural rollers 62, 64-67 and the endless belt 68 run about these rollers 62, 65-67 constitute the “pressing member” of the invention. The two nip rollers 62, 64 press on the endless belt 68 to bring a part of the outside surface thereof into pressure contact with the heat roller 61 whereby the nip portion 69 is established.

According to the embodiment, the nip roller 62 equivalent to the inlet side of the nip portion 69 is simply abutted against the heat roller 61 whereas the nip roller 64 equivalent to the exit side of the nip portion 69 is strongly pressed against the heat roller 61 by means of the helical compression spring 63. Hence, the nip pressure presents a pressure distribution as shown in FIG. 10, as distributed along the length of the nip portion 69 in the direction P, Q of transport of the recording medium 4 or along the nip width. That is, a nip pressure at the inlet site of the nip portion 69 is lower than that at the exit site thereof. Accordingly, when the recording medium 4 is delivered from the transfer unit 40 to the fixing unit 60, the fixing process takes place in association with the following phenomena.

Firstly, the recording medium 4 delivered to the fixing unit 60 carries the unfixed toner image TI on one side S1 thereof (the front side in this embodiment, see FIG. 9), the toner image formed with the liquid developer. Prior to the fixing process, the solid toner T and the carrier liquid L is present on the one side of the recording medium 4 in a mixed state. When the recording medium 4 enters the inlet site of the nip portion 69 as carrying thereon the solid toner T and the carrier liquid L in the mixed state, the recording medium 4 is subjected to the relatively lower nip pressure. It is noted here that the “relatively lower nip pressure” means a nip pressure suited for fixing the toner T in the liquid developer to the recording medium 4 or a pressure lower than the nip pressure at the exit site of the nip portion. The relatively lower nip pressure may be decided according to the components of the liquid developer, the arrangement of the apparatus and the material of the recording medium 4.

Where the relatively lower nip pressure is applied to the recording medium 4 at the inlet site of the nip portion 69, the carrier liquid L is effectively prevented from being greatly decreased during the passage through the inlet site of the nip portion 69. While the recording medium 4 with a sufficient amount of carrier liquid remaining thereon is moved to the exit of the nip portion 69, the toner T is molten by the heat roller 61. Subsequently, the final stage of the fixing process is performed wherein the higher nip pressure than that at the inlet site is applied to the recording medium at the exit site of the nip portion 69. In this process, the molten toner T penetrates into the recording medium 4 to produce an anchor effect, which contributes to an even higher fixing strength. As described above, the final stage of the fixing process is carried out at the exit site of the nip portion 69 in the state where the carrier liquid L remains on the recording medium. This is effective to prevent a so-called offset where the toner T migrates to the heat roller 61.

As described above, the embodiment is arranged such that the nip pressure at the inlet site of the nip portion 69 is lower than that at the exit site of the nip portion 69. Therefore, the toner image TI formed with the liquid developer including the toner T dispersed in the carrier liquid L can be fixed to the recording medium 4 with excellent fixing performance.

Since the nip pressure at the inlet site of the nip portion 69 is lower than the nip pressure at the exit site thereof, as described above, an infeed performance for feeding the recording medium 4 into the nip portion 69 is improved so that the recording medium 4 may be smoothly and positively introduced into the nip portion 69. Accordingly, the fixing process may be carried out in a stable manner. This also leads to a merit that the fixing unit 60 is notably reduced in the incidence of jamming of the recording medium 4.

### Seventh Embodiment

In the foregoing sixth embodiment, a part of the outside surface of the endless belt 68 is held in pressure contact with the heat roller 61 thereby to define the nip portion 69. However, as suggested by another embodiment shown in FIG. 1, an alternative arrangement may be made such that a pressure pad is used in place of the two nip rollers 62, 64 for holding a part of the endless belt 68 in pressure contact with the heat roller 61.

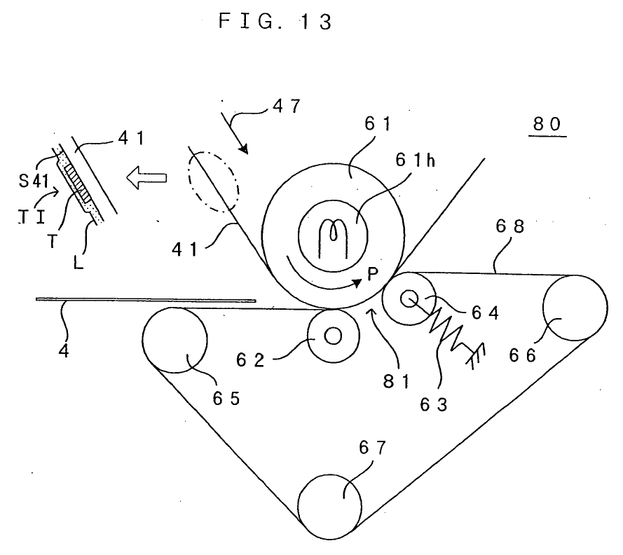

FIG. 11 is a diagram showing a fixing unit as a fixing device according to a seventh embodiment of the invention. FIG. 12 is a graph representing a nip pressure distribution at a nip portion of the fixing unit of FIG. 11. Referring to these figures, the arrangement and operations of the fixing unit 60 according to the seventh embodiment will hereinbelow be described in details. The following description will focus on difference from the sixth embodiment. This fixing unit 60 is provided with the pressure pad 71 in stead of the nip rollers. Specifically, the fixing unit includes the three rollers 65-67, about which the endless belt 68 is run. The motor is operated to apply the rotational drive force thereof to one of these rollers thereby driving the endless belt 68 into a cycling motion in a direction of the arrow Q shown in the figure. Disposed inside of the endless belt 68 is the pressure pad 71 in a non-rotatable state, the pressure pad holding the endless belt 68 in pressure contact with the heat roller 61 for the overall length of the nip portion thereby establishing the nip portion 69. Thus, the outside surface of the endless belt 68 contacts the heat roller 61 at place where the pressure pad 71 is located, thereby defining the nip portion 69. The fixing process is carried out by passing the recording medium 4, delivered from the transfer unit 40, through the nip portion 69. According to the embodiment, the plural rollers 65-67, the endless belt 68 run about the rollers 65-67 and the pressure pad 71 constitute the “pressing member” of the invention.

As shown in FIG. 11, the pressure pad 71 includes the two pad portions 711, 712. The pad portion 711 is simply placed at the inlet site of the nip portion 69, whereas the other pad portion 712 is not only arranged to abut against the heat roller 61 but is also pressed against the heat roller 61 by the helical compression spring 72. Hence, the nip pressure presents a pressure distribution as show in FIG. 12, as distributed along the length of the nip portion 69 in the direction P, Q of transport of the recording medium 4 or along the nip width. That is, a nip pressure at the inlet site of the nip portion 69 is lower than that at the exit site of the nip portion 69.

When the recording medium 4 is delivered from the transfer unit 40 to the fixing unit 60 thus arranged, the fixing process is carried out the same way as in the sixth embodiment. When the recording medium 4 delivered to the fixing unit 60 enters the inlet site of the nip portion 69, the recording medium is subjected to the relatively lower nip pressure. Therefore, the carrier liquid L may be effectively prevented from being greatly decreased during the passage through the inlet site of the nip portion 69. While the recording medium 4 with a sufficient amount of carrier liquid remaining thereon is moved to the exit of the nip portion 69, the toner T is molten by the heat roller 61. Subsequently, the final stage of the fixing process is performed wherein the higher nip pressure than that at the inlet site is applied to the recording medium. Therefore, the fixing process may be performed while effectively preventing the so-called offset where the toner T migrates to the heat roller 61. Furthermore, the device has a good infeed performance for feeding the recording medium 4 into the nip portion 69 so that the fixing process may be carried out with the recording medium smoothly and positively transported.

In addition, the seventh embodiment offers the following working effect by virtue of the nip portion 69 defined using the pressure pad 71. According to the embodiment, a constant nip pressure is provided at the inlet site of the nip portion 69, as shown in FIG. 12. This ensures that the moving speed of the recording medium 4 is positively prevented from fluctuating during the passage through the nip portion 69. As a result, the slippage of the recording medium is obviated so that a favorably fixed toner image is obtained.

### Eighth Embodiment

Although both the sixth and seventh embodiments adopt the so-called belt nip system, the nip system is not limited to this. For instance, the roller nip system may be employed similarly to the third embodiment. It is noted, however, that the eighth embodiment has an arrangement wherein out of the plural pressure rollers 73-75 equivalent to the “pressing member” of the invention, the roller 73 on the inlet side of the nip portion 69 has a lower pressing force than the roller 75 on the exit side of the nip portion 69. Hence, the nip pressure presents the same pressure distribution as that shown in FIG. 10, as distributed along the length of the nip portion 69 in the direction P of transport of the recording medium 4 or along the nip width. Accordingly, when the recording medium 4 is delivered from the transfer unit 40 to the fixing unit 60 thus arranged, the fixing process is performed in a similar manner to the sixth and seventh embodiments. That is, the carrier liquid L is effectively prevented from being greatly decreased at the inlet site of the nip portion 69 so that the recording medium with a sufficient amount of carrier liquid remaining thereon is moved to the exit of the nip portion 69, where the final stage of the fixing process is performed by applying the higher nip pressure than that at the inlet site. Therefore, the fixing process may be performed while effectively preventing the so-called offset where the toner T migrates to the heat roller 61. Furthermore, the device has a good infeed performance for feeding the recording medium 4 into the nip portion 69 so that the fixing process may be carried out with the recording medium smoothly and positively transported.

It is noted here that at least the roller 75 on the exit side may be further provided with the heating means such as a heater 75h. The device can increase the fixing strength of the toner T to the recording medium 4 by heating the roller 75, thus achieving an even higher fixing performance.

### Ninth Embodiment

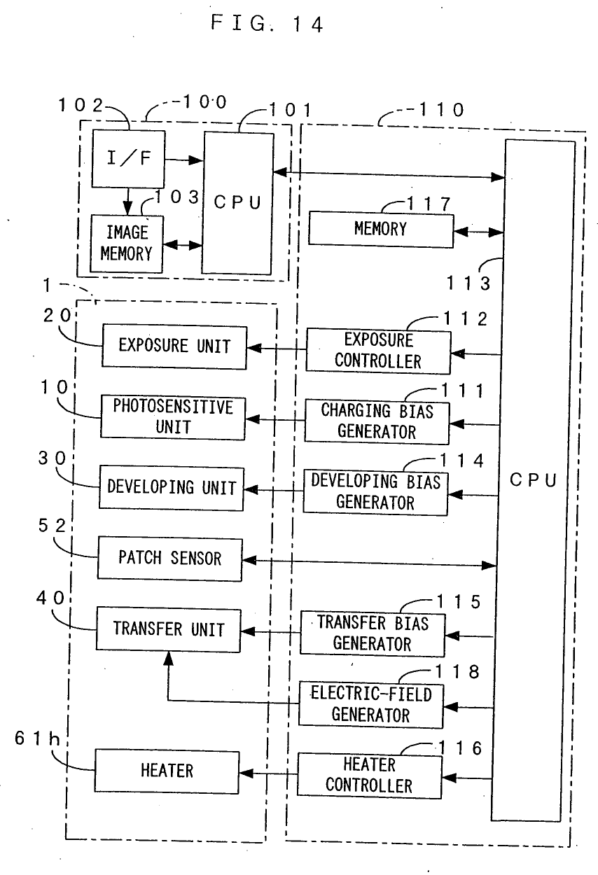

In the foregoing sixth to eighth embodiments, the toner image is transferred to the recording medium 4 and thereafter, the fixing process is performed by the fixing unit 60. However, the invention is also applicable to the image forming apparatus adapted to perform the transfer process and the fixing process at a time. Such an apparatus will hereinbelow be described with reference to FIG. 13.

FIG. 13 is a diagram showing a transferring/fixing unit as a fixing device according to a ninth embodiment of the invention. The transferring/fixing unit 80 concurrently performs both the transfer process and the fixing process at the secondary transfer position. The unit principally differs from that of the sixth embodiment in that the transfer roller 45 of the transfer unit 40 is replaced by the heat roller 61 as a “heat contact member” of the invention, and that the roller 48 is replaced by the rollers 62, 64-67, helical compression spring 63 and endless belt 68 which serve as the “pressing member” of the invention. That is, the transferring/fixing unit 80 has an arrangement wherein the heat roller 61 is arranged to be able to contact the back side of the intermediate transfer belt 41 as the “image carrier” of the invention. The heat roller 61 incorporates therein the heater 61h such that a fixing temperature in the transferring/fixing unit 80 may be adjusted to an arbitrary level by controlling the operation of the heater 61h based on a control signal from the heater controller 116. Otherwise, the embodiment is arranged the same way as the image forming apparatus of FIG. 1. Therefore, the principal part of the transferring/fixing unit 80 is described but the other parts are not described here.

Similarly to the sixth embodiment, the outside surface of the endless belt 68 is pressed against the front side S41 of the intermediate transfer belt 41, run about the heat roller 61, at its portion stretched between the nip rollers 62, 64, thereby defining the nip portion 81. Therefore, when the recording medium 4 is delivered to the transferring/fixing unit 80, both the transfer process and the fixing process can be performed at a time by passing the recording medium 4 through the nip portion 81.

In this embodiment, as well, the nip roller 62 equivalent to the inlet side of the nip portion 81 is simply abutted against the heat roller 61, whereas the nip roller 64 equivalent to the exit side of the nip portion 81 is strongly pressed against the heat roller 61 by the helical compression spring 63. Thus, the nip pressure presents the pressure distribution as shown in FIG. 10, as distributed along the length of the nip portion 81 in the direction P of transport of the recording medium 4 or along the nip width. Therefore, the embodiment has not only an advantage of concurrently performing the transfer process and the fixing process but also has an advantage of achieving an excellent fixing performance because the transferring and fixing processes are performed while effectively preventing the so-called offset where the toner T migrates to the heat roller 61. Furthermore, the device has a good infeed performance for feeding the recording medium 4 into the nip portion 69 so that the fixing process may be carried out with the recording medium smoothly and positively transported.

Although the embodiment adopts the same belt nip system as the sixth embodiment, the nip system is not limited to this. The same belt nip system as that of the seventh embodiment or the same roller nip system as that of the eighth embodiment are also usable.

### Tenth Embodiment

According to the sixth to the ninth embodiments, the fixing process is performed simply by passing the recording medium 4 through the nip portion 69 or the transferring/fixing process is performed simply by passing the intermediate transfer belt 41 and the recording medium 4 through the nip portion 81. Alternatively, as shown in FIG. 14, there may be further provided electric-field generator (electric-field generating means) 118 for generating, in the nip portion 69 or 81, an electric field so directed as to move the toner T in the liquid developer 32 toward the recording medium 4. In this case, the toner T is concentrated on the recording medium 4 side whereas the carrier liquid L is concentrated on the heat roller 61 side. Thus, the carrier liquid L is present at space between the toner T and the heat roller 61 thereby effectively preventing the migration or offset of the toner T to the heat roller 61. Thus, the fixing performance is even further improved.

<Miscellanea>

It is to be noted that the invention is not limited to the foregoing embodiments and various changes or modifications may be made thereto within the scope of the invention. For instance, while the foregoing embodiments use the non-volatile carrier as the carrier liquid for use in the liquid developer, the invention is also applicable to a liquid developer employing a volatile carrier.

While the foregoing embodiments have been described by way of example of the printer for printing on the recording medium an image sent from the external apparatus such as the host computer, the invention is not limited to this. The invention is applicable to all the types of image forming apparatuses for forming the toner image using the liquid developer. Although the foregoing embodiments apply the invention to the image forming apparatuses for monochromatic printing, the subject of the application of the invention is not limited to the above but also includes color image forming apparatuses.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

1. A fixing device comprising:
a contact member arranged to be able to contact one side of a recording medium on which side an unfixed toner image is carried, the toner image formed with a liquid developer including a toner dispersed in a carrier liquid; and
a pressing member pressing on the other side of said recording medium for pressing said recording medium against said contact member,
wherein said unfixed toner image is fixed to the one side of said recording medium by passing said recording medium through a nip portion defined between said contact member and said pressing member; and
wherein a nip pressure at an inlet site of said nip portion is set higher than a nip pressure at an exit site of said nip portion.

2. A fixing device as claimed in claim 1,
wherein said contact member includes a heat roller;
wherein said pressing member includes a plurality of rollers including two nip rollers adjoining said heat roller and an endless belt run about said plural rollers and capable of moving in a cycling manner, and establishes said nip portion by holding a part of an outside surface of said endless-belt in pressure contact with said heat roller by means of said two nip rollers; and
wherein out of said two nip rollers, the nip roller on the inlet side of said nip portion has a higher pressing force for pressing the endless belt against said heat roller than a pressing force of the nip roller on the exit side of said nip portion for pressing said endless belt against said heat roller.

3. A fixing device as claimed in claim 1,
wherein said contact member is a heat roller; and
wherein said pressing member includes a plurality of rollers, an endless belt run about said plural rollers and capable of moving in a cycling manner and a pressure pad disposed inside of said endless belt in a non-rotatable state for holding said endless belt in pressure contact with said heat roller for the overall length of said nip portion, thereby establishing said nip portion.

4. A fixing device as claimed in claim 1,
wherein said contact member includes a heat roller;
wherein said pressing member includes a plurality of rollers in pressure contact with said heat roller, said plural rollers cooperating with said heat roller to define said nip portion; and
wherein the roller on the inlet side of said nip portion has a higher pressing force on said heat roller than that of the roller on the exit side of said nip portion.

5. A fixing device as claimed in claim 4, further comprising heating means for heating said roller on the exit side.

6. A fixing device as claimed in claim 1, further comprising electric-field generating means for generating, in said nip portion, an electric field directed to move the toner in the liquid developer toward said recording medium.

7. An image forming apparatus comprising:
image forming means for forming a toner image on an image carrier by using a liquid developer including a toner dispersed in a carrier liquid;
transfer means for transferring the toner image, formed by said image forming means, to one side of a recording medium; and
fixing means having the same arrangement as the fixing device as claimed in claim 1 and operating to fix the unfixed toner image to said recording medium, the unfixed toner image transferred to the one side of said recording medium by said transfer means.

8. An image forming apparatus comprising:
image forming means for forming a toner image on a surface of an image carrier by using a liquid developer in which a toner is dispersed in a carrier liquid; and
transferring/fixing means for concurrently transferring and fixing said toner image to one side of a recording medium,
wherein said transferring/fixing means includes a contact member arranged to be able to contact a back side of said image carrier and a pressing member pressing on the other side of said recording medium for pressing said recording medium against the surface of said image carrier, and performs the transferring/fixing process by passing said recording medium and said image carrier through a nip portion defined between said contact member and said pressing member; and
wherein a nip pressure at an inlet site of said nip portion is set higher than a nip pressure at an exit site of said nip portion.

9-10. (canceled)

11. A fixing device as claimed in claim 9,
wherein said heat contact member is a heat roller,
wherein said pressing member includes a plurality of rollers, an endless belt run about said plural rollers and capable of moving in a cycling manner and a pressure pad disposed inside of said endless belt in a non-rotatable state for holding said endless belt in pressure contact with said heat roller for the overall length of said nip portion thereby establishing said nip portion.

12. A fixing device as claimed in claim 9,
wherein said heat contact member includes a heat roller;
wherein said pressing member includes a plurality of rollers in pressure contact with said heat roller, said plural rollers cooperating with said heat roller to establish said nip portion; and
wherein a roller on the inlet side of said nip portion has a lower pressing force on said heat roller than a pressing force of a roller on the exit side of said nip portion.

13. A fixing device as claimed in claim 12, further comprising heating means for heating said roller on the exit side.

14. A fixing device as claimed in claim 9, further comprising electric-field generating means for generating, in said nip portion, an electric field directed to move the toner in the liquid developer toward said recording medium.

15. An image forming apparatus comprising:
image forming means for forming a toner image on an image carrier by using a liquid developer including a toner dispersed in a carrier liquid;
transfer means for transferring the toner image, formed by said image forming means, to one side of a recording medium; and
fixing means having the same arrangement as the fixing device as claimed in claim 9 and operating to fix the unfixed toner image to said recording medium, the unfixed toner image transferred to the one side of said recording medium by said transfer means.

16. An image forming apparatus comprising:
image forming means for forming a toner image on a surface of an image carrier by using a liquid developer including a toner dispersed in a carrier liquid; and
transferring/fixing means for concurrently transferring and fixing said toner image to one side of said recording medium,
wherein said transferring/fixing means includes a heat contact member arranged to be able to contact a back side of said image carrier while heating the back side thereof and a pressing member pressing on the other side of said recording medium for pressing said recording medium against the surface of said image carrier, and performs the transferring/fixing process by passing said recording medium and said image carrier through a nip portion defined between said heat contact member and said pressing member; and
wherein a nip pressure at an inlet site of said nip portion is set lower than a nip pressure at an exit site of said nip portion.
